(19) United States
(12) Patent Application Publication
(10) Pub. No.: US 2001/0016968 A1
(43) Pub. Date: Aug. 30, 2001

(54) Nursery gate hinge and a nursery gate

(76) Inventor: John Rogers, Stafford (GB)

Correspondence Address: BARNES & THORNBURG, 11 South Meridian Street, Indianapolis, IN, 46204, US

(21) Appl. No.: 09/726,105

(22) Filed: Nov. 29, 2000

(30) Foreign Application Priority Data
Nov. 29, 1999 (GB) UK9928075.2

(51) Int. Cl. E05D 7/00

(52) U.S. Cl. 16/250; 16/387

(57) ABSTRACT

A nursery gate 10 comprises a framed part 12 secured in an opening with a door part 14 hinged thereto by means of a hinge assembly 16. The assembly 16 comprises a first hinge part 18 attached to the frame 12 and a second hinge part 20 attached to the door 14 hinged together by means of a hinge pin 22. The first and second hinge parts 18, 20 and hinge pin 22 are covered by a shroud assembly 24. The shroud assembly 24 comprises a first shroud part 26 mounted on the frame 12 and the second shroud part 28 mounted on the door 14 which, together, envelope the first and second hinge parts 18, 20 and the hinge pin 22 and prevent access thereto.

The invention relates to a nursery gate hinge and to a nursery gate.

Nursery gates are well known and generally comprise a frame which is secured in an opening, such as a doorway. The frame has a door hinged therewithin, the door being securable to prevent infants from passing through the opening whilst allowing the door in the doorway to remain open and adults to pass through the door in the nursery gate. The doors to nursery gates are generally hinged to the frame and various hinge mechanisms are known. One hinge mechanism comprises a first hinge part attached to the frame, a second hinge part attached to the door, the first and second hinge parts being hinged together by means of a hinge pin. That mechanism provides a straight forward hinge assembly which can be manufactured easily from inexpensive materials. One of the drawbacks of that hinging mechanism is that there is a possibility that an infant's fingers can be caught in the hinge as the door to the nursery gate is opened causing discomfort, pain and possibly injury.

It is an object of the present invention to provide an improved nursery gate hinge and an improved nursery gate.

According to the first aspect of the invention there is provided a nursery gate hinge comprising first and second hinge parts hinged together by means of a hinge pin, a shroud assembly comprising a first shroud part substantially surrounding the first hinge part and a second shroud part substantially surrounding the second hinge part, the shroud parts being arranged to cover the first and second hinge parts and to prevent access thereto.

In that way, the shroud assembly around the hinge mechanism prevents an infant from inserting their fingers in the hinge mechanism and thus eliminates the risk of pinching of the fingers or damage to the fingers of the infant when the door is opened.

Preferably one shroud part is received within the other shroud part.

The first shroud part is preferably a cup-like member comprising a substantially circular base and a substantially circular peripheral wall defining an open mouth and surrounding the first hinge part. The second shroud part is preferably a cup-like member comprising a substantially circular base and a substantially circular peripheral wall defining an open mouth and surrounding the second hinge part. Where the first and second shroud parts are cup-like members, the cup-like members are preferably arranged mouth to mouth.

Preferably the first shroud part is received within the second shroud part. The first and second shroud parts are preferably arranged so as to enable relative rotation therebetween.

The first hinge part preferably comprises a plate having an aperture formed therethrough for receiving the hinge pin. The second hinge part may comprise a plate having an aperture therein for receiving the hinge pin. The first hinge part preferably comprises two plates spaced apart from one another and joined by a connecting web, each plate having a respective aperture formed therein co-axially with the aperture in the other plate for receiving the hinge pin. In such a case the plate of the second hinge part is arranged between the two plates of the first hinge part so that the apertures in the plates of the first hinge part and the aperture in the plate of the second hinge part lie co-axially.

In a preferred embodiment a space is provided between the first and second hinge parts to allow movement therebetween. That provides for the case where the door of the nursery gate is released by lifting of the door to release a latch. Preferably, where the first hinge part comprises two plates spaced by a connecting web and a second hinge part plate is arranged between the first plate of the first hinge part a space is provided between the plate of the second hinge part and one of the plates of the first hinge parts.

A space is provided between the first and second hinge parts to allow relative movement and where one shroud part is received within the other shroud part, the height of the portion of the shroud part received within the other shroud part is preferably greater than the space between the first and second hinge parts. In other words, movement of the first and second hinge parts to close the space therebetween would not expose the hinge mechanism.

Where a space is provided between the first and second hinge parts to allow relative movement therebetween, there is provided a spacer block which can be fitted into the space to prevent such relative movement.

According to a second aspect of the invention there is provided a nursery gate comprising a frame secured within an opening and a door hinged to the frame by means of a hinge, the hinge comprising first and second parts hinged together by means of a hinge pin, a shroud assembly comprising a first shroud part substantially surrounding the first hinge part and a second shroud part substantially surrounding the second hinge part, the shroud parts being arranged to cover the first and second hinge parts and to prevent access thereto.

In a preferred embodiment the first hinge part is attached to the frame of the nursery gate and the second hinge part is attached to the door of the nursery gate. All of the consistory clauses relating to the first aspect of the invention apply equally to the second aspect of the invention.

A hinge in accordance with the invention will now be described in detail by way of example and with reference to the accompanying drawings in which:

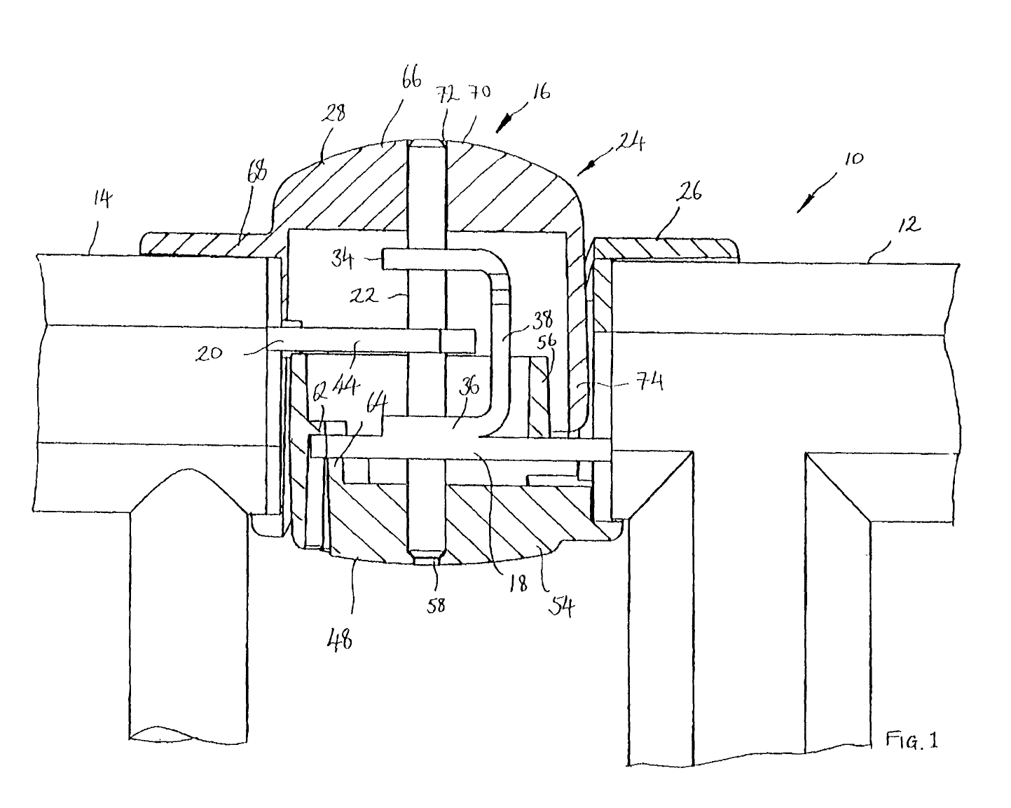

FIG. 1 is a cross section through a hinge in accordance with the invention,

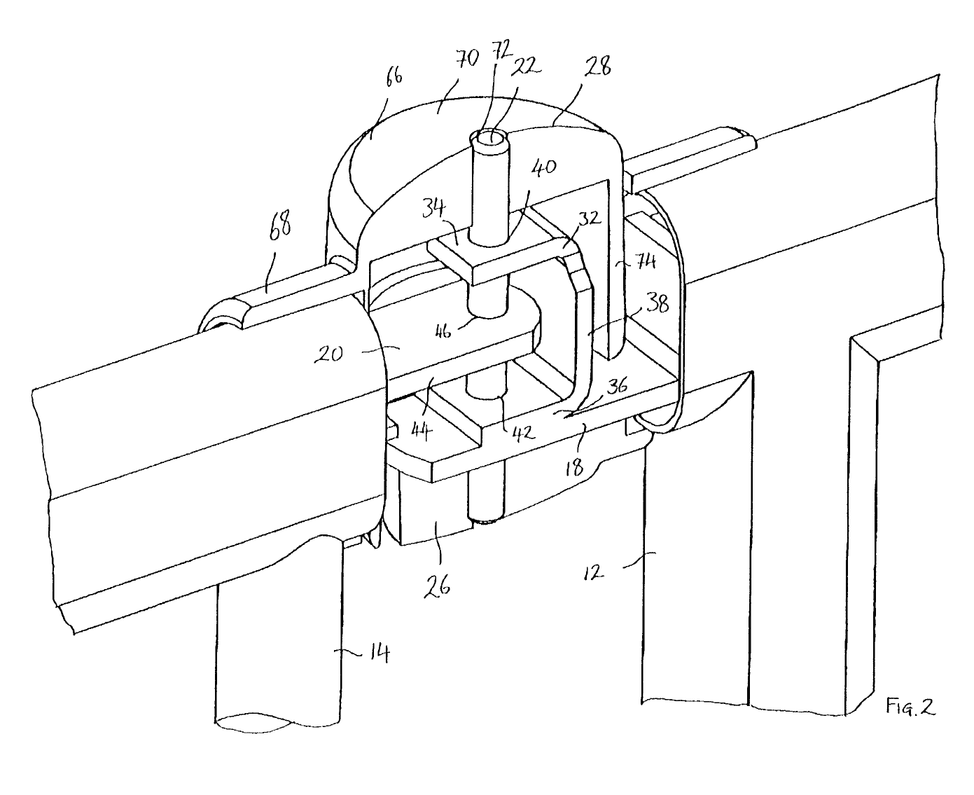

FIG. 2 is a cut-away perspective view of the hinge of FIG. 1.,

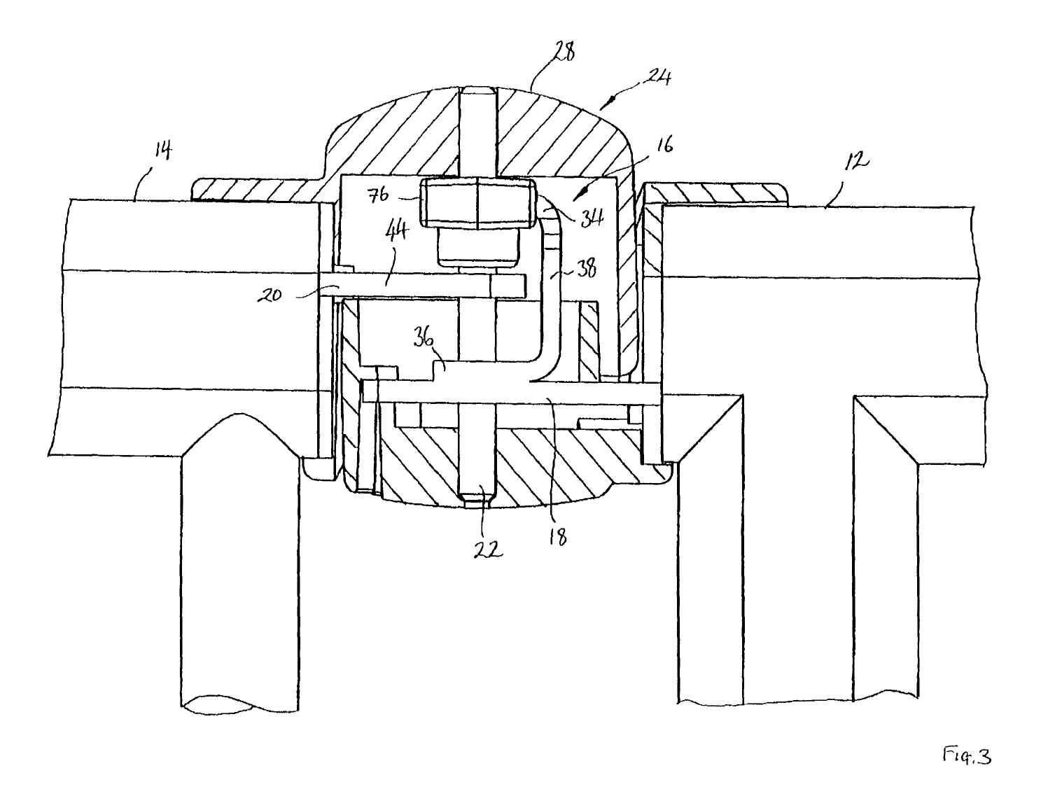

FIG. 3 is a cross-section of the hinge of FIGS. 1 and 2 with a spacer block inserted between the first and second hinge parts,

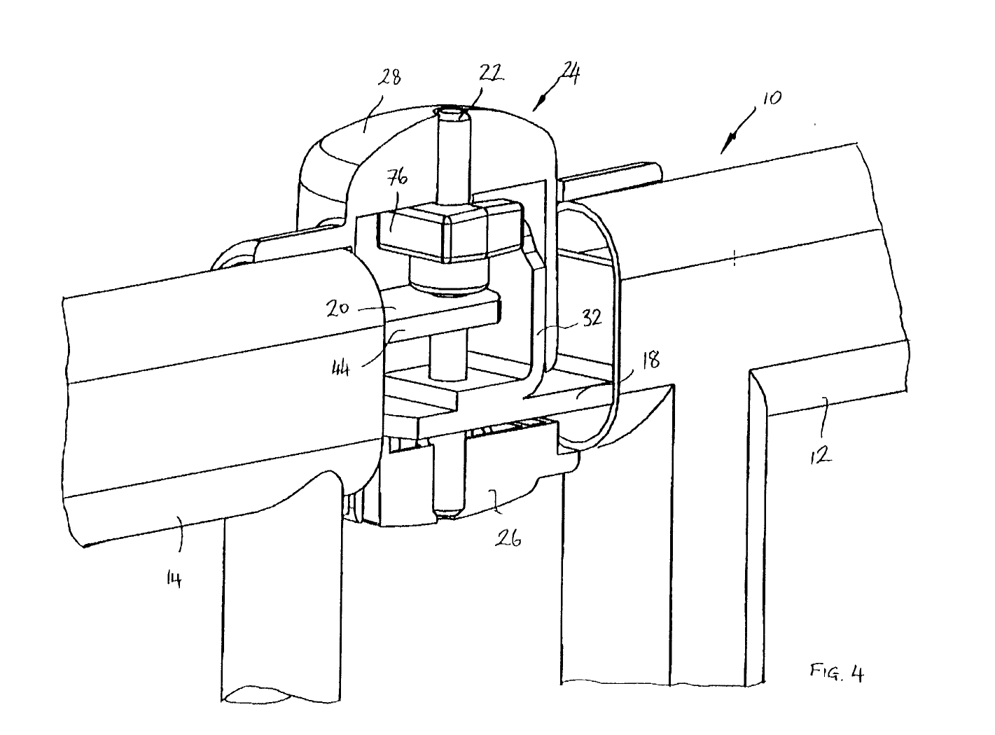

FIG. 4 is a cut-away perspective view of the hinge of FIG. 3,

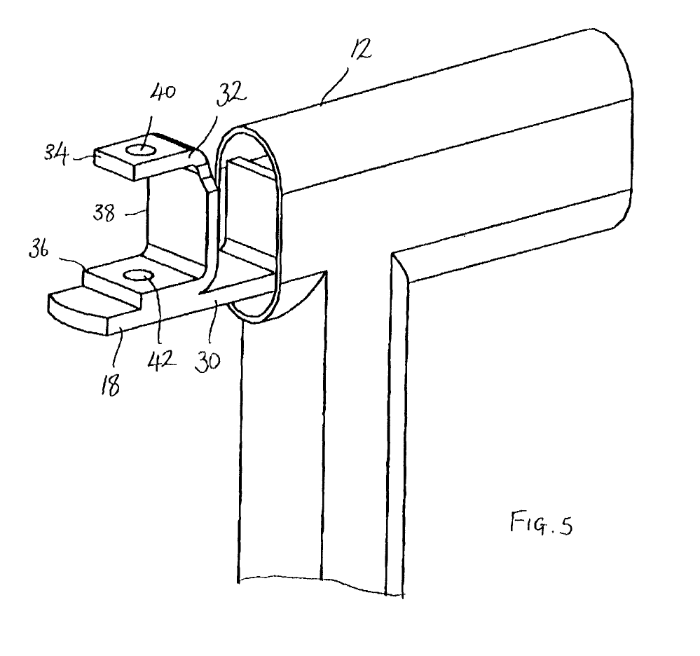

FIG. 5 is a perspective view of part of the frame of the nursery gate and the first hinge part,

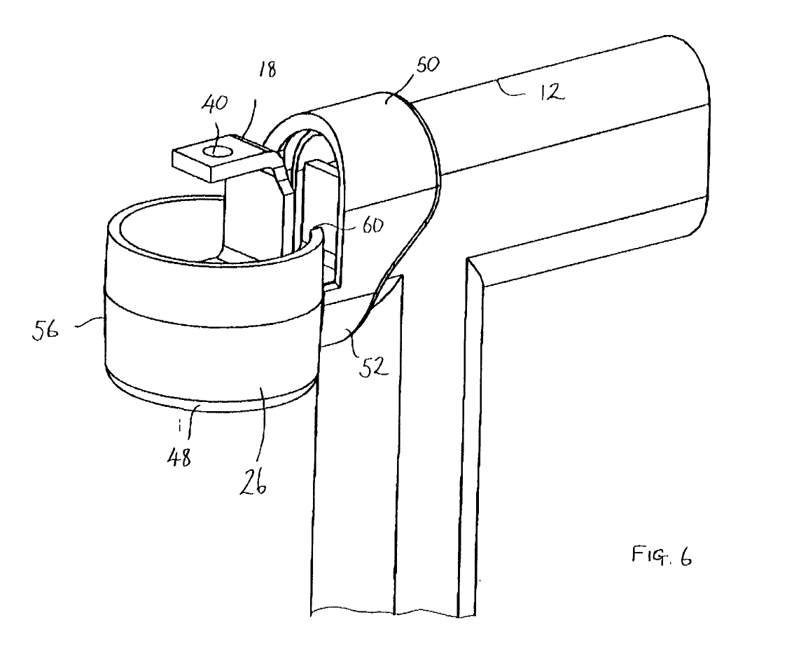

FIG. 6 is a perspective view similar to FIG. 5 shown with the first shroud part surrounding the first hinge part,

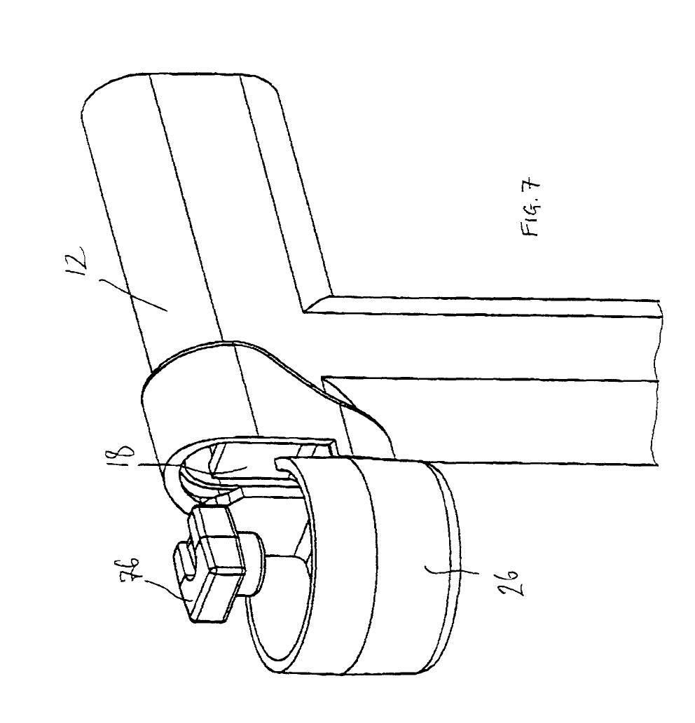

FIG. 7 is a view similar to FIGS. 5 and 6 showing a spacer block in place on the first hinge part,

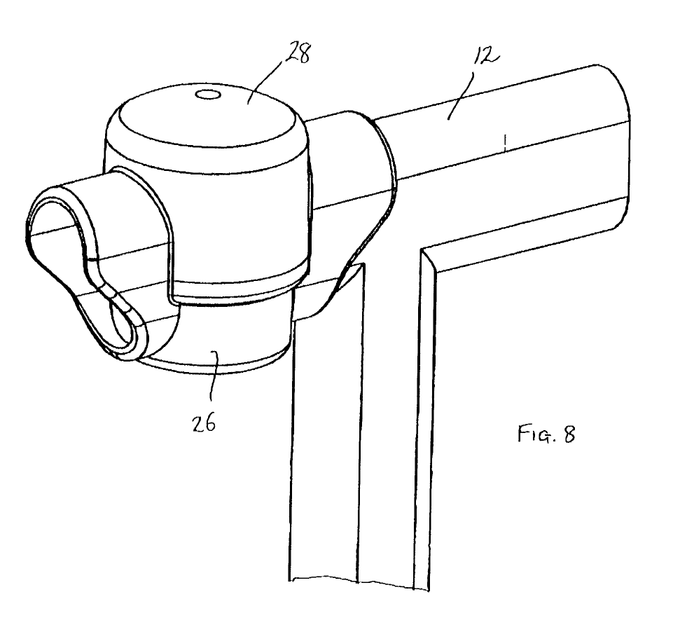

FIG. 8 is a view similar to FIGS. 5 to 7 showing the second shroud part in place,

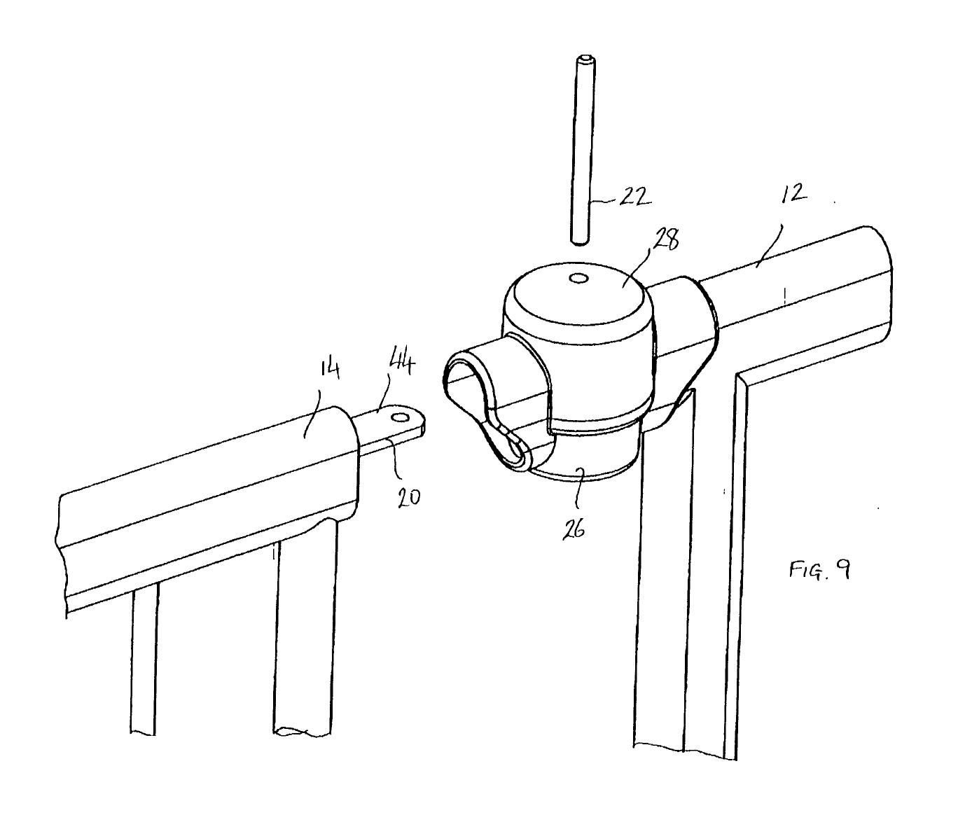

FIG. 9 is a view similar to FIGS. 5 to 8 showing the door and second hinge part about to be inserted into the hinge mechanism together with the hinge pin, and

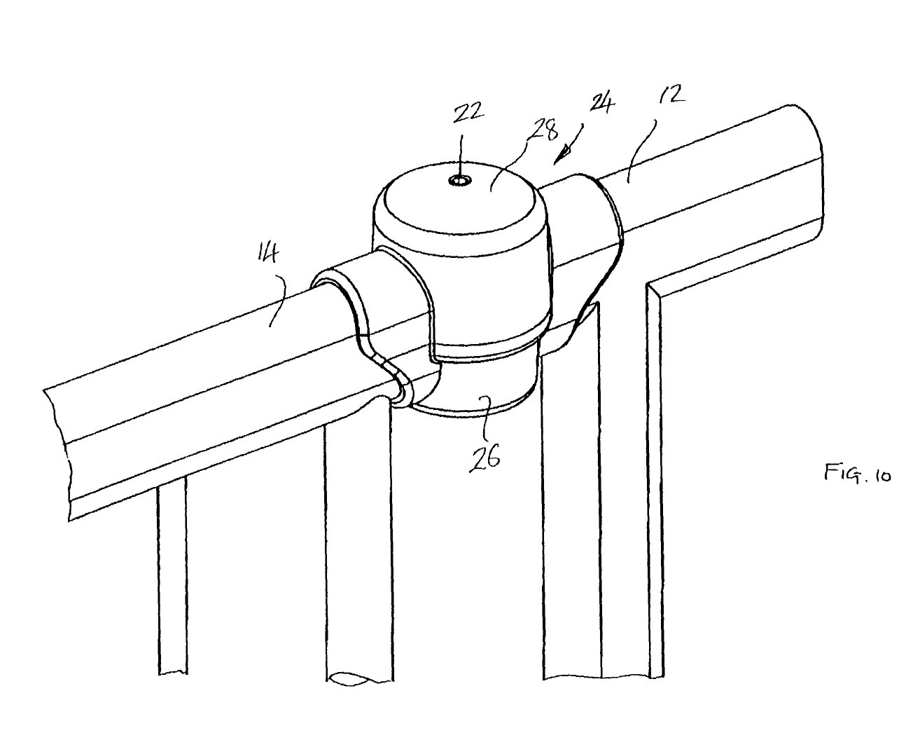

FIG. 10 is a view similar to FIGS. 5 to 9 showing the assembled hinge on the nursery gate.

In FIG. 1 a nursery gate 10 comprises a framed part 12 secured in an opening with a door part 14 hinged thereto by means of a hinge assembly 16. The assembly 16 comprises a first hinge part 18 attached to the frame 12 and a second hinge part 20 attached to the door 14 hinged together by means of a hinge pin 22. The first and second hinge parts 18, 20 and hinge pin 22 are covered by a shroud assembly 24. The shroud assembly 24 comprises a first shroud part 26 mounted on the frame 12 and the second shroud part 28 mounted on the door 14 which, together, envelope the first and second hinge parts 18, 20 and the hinge pin 22 and prevent access thereto.

The first hinge part 18 is best shown in FIG. 5 and comprises an L-shaped member 30 part of which is received in the frame 12 and part of which protrudes therefrom. A C-shaped member 32 comprising plate like arms 34, 36 and an interconnecting web 38 these are connected to the protruding part of the L-shaped member 30 by means of welding the arm 36 to the protruding part of the L-shaped member 30. An aperture 40 is formed through the arm 54 of the C-shaped member 32. A further aperture 42 is provided through the arm 36 and the protruding part of the L-shaped member 30. The aperture 42 is co-axial with the aperture 40.

The second part 20 of the hinge comprises an elongate plate-like member 44 which is secured within the door 14 and part of which protrudes therefrom. The protruding part of the plate-like member 44 has an aperture 46 formed therethrough. As shown in FIG. 2, the hinge mechanism 16 is arranged so that the apertures 40, 42 and 46 are arranged co-axially with the protruding part of the plate-like member 44 of the second part 20 arranged between the arms 34 and 36 of the C-shaped member 32 of the first part of the hinge mechanism. With the aperture 40, 42 and 46 aligned the hinge pin 22 is inserted through the apertures to secure the door 14 to the frame 12.

The shroud assembly 24 covers the hinge mechanism 16 as shown in FIG. 10. The first part of the shroud assembly 26 shown best in FIGS. 1, 2 and 5. The first shroud part 26 comprises a cup portion 48 and collar portion 50. The cup-like portion 48 extends the protruding part of the first hinge part 18. The collar portion 50 surrounds part of the frame 14. The collar portion 50 and cup-like portion 48 are connected by a web of material 52.

The cup-like portion 48 comprises a circular base 54 with and upstanding peripheral wall 56. The base 54 has a door 58 shown in FIG. 1 which is arranged to receive the hinge pin 22 with an interference fit. A gap is provided between the cup-like member 48 and the collar portion 50. The wall 56 has space 60 to receive the protruding part of the first hinge part 18. The wall 56 has a height such that it extends from beneath the protruding part of the L-shaped member 30 of the first hinge part to approximately half way up the connecting web 38 of the C-shaped member 32 of the first hinge part 18.

The collar portion 50 extends around part of the frame 14 and is shaped so as to fit around the frame 14 with a frictional fit. The cup-like member 48 further includes an inwardly projecting flange 62 projecting from the inner face of the peripheral wall 56 opposite to the space 60. In addition an upstanding flange 64 projects from the base 54 of the cup-like member adjacent to flange 62 so as to define a space between the bottom surface of the flange 62 and the top surface of the flange 64. The space is arranged to receive the tip of the protruding part of the L-shaped member 30 of the first hinge part 18, best shown in FIG. 1. The flanges 62 and 64 are made from resilient material, as is the remainder of the cup-like member 48 so that the cup-like member 49 is retained on the frame 12 by the gripping action of the flanges 62, 64 on the protruding part of the hinge 18 and the gripping of the collar portion 50 around the frame 12. The other part of the shroud assembly 24 comprises a cup-like portion 66 and a collar portion 68. The cup-like portion 66 comprises a circular base 70 having a bore 72 formed therethrough to accommodate the hinge pin 22. The circular base 70 has a substantially circular peripheral wall 74 extending therefrom. A space is provided in the wall 74 to allow passage of the plate-like member 44 of the second hinge part 20. The wall 74 is arranged to extend downwardly from the base 70.

The collar portion 68 is arranged to surround part of the door 14 with a sectional interference fit. As for the lower shroud part the upper shroud part 28 is made from a resilient material and so the collar portion 68 is retained resiliently on the door 14. Part of the wall 74 lies in the gap between the cup portion 48 and collar portion 50 of the first part of the shroud assembly.

It can be seen clearly from FIG. 10 that the shroud assembly 24 completely envelopes the hinge mechanism 16 and prevents the fingers of infants from becoming trapped in the hinge mechanism. The shroud assembly parts are dimensioned so that there is a sliding fit between the walls 56 and 74 so that there is no gap in which fingers can be caught.

In some nursery gates the door opening mechanism relies on the door being lifted relative to the frame and that facility is provided by the space between the plate-like member 44 of the second part of the hinge 20 and the upper arm 34 of the C-shaped member 32 of the first part of the hinge 18. The door 14 can be lifted relative to the frame 12 and the plate member 44 of the second part of the hinge 20 will slide along the hinge pin 22 until its abuts the upper arm 34 of the C-shaped member 32 of the first part of the hinge 18. In the present invention the overlap of the walls 56 and 74 is more than the distant between the plate-like member 44 and the upper arm 34 so that the hinge mechanism is not exposed during lifting of the door. That can be clearly seen in FIG. 1.

In the embodiments of FIGS. 3 and 4 the hinge is substantially similar to that shown in FIG. 1 but the door mechanism does not require lifting in order to open the door. In such a case, it is desirable to prevent lifting the door so as to reduce wear and tear on the hinge mechanism. Accordingly, a hinge spacer 76 is provided and is fitted on to the arm 34 of the C-shaped member 32 of the first hinge part 18. Hinge spacer 76 extends into the gap between the plate-like member 44 of the second hinge part and the upper arm 34 of the C-shaped member 32 of the first hinge part 18 so as to prevent relative movement between the first and second hinge parts.

FIGS. 5 to 10 show the sequence of assembly of component parts of the hinge mechanism 16 and the shroud assembly 24 on to the nursery gate pen. In FIG. 5 the first hinge part 18 is located within the upper part of the frame 12. The first shroud part 26 is located around the first hinge part 18 and on the frame 12 and is retained thereon by the resilience of the material of the first shroud part 26. FIG. 7 shows the optional location of the hinge spacer 76 on the upper arm 34 of the C-shaped member 32 of the first hinge part 18.

In FIG. 8 the upper part 28 of the shroud assembly 24 is located over the first part of the shroud assembly and first hinge part.

FIG. 9 shows the assembly of the door 14 into the same 12 where the second hinge part 20 is received into the hinge sub-assembly. The plate-like member 44 is received through the gap in the wall 74 of the upper shroud part 28 and the hinge pin 22 is then inserted through the bore 72 in the upper shroud part 28 and the apertures 40, 42 and 46 in the hinge parts and into the bore 58 of the lower shroud part. The bore 58 in the lower shroud part receives the hinge pin 22 with an interference fit. FIG. 9 shows the final hinge assembly in which the shroud assembly 24 completely envelopes the hinge assembly 16 and prevents access thereto.

The hinge according to the invention prevents fingers from becoming trapped in the hinge assembly but allows the door 14 to be lifted in nursery gates where lifting the door is required to open the door. Provision of the hinge spacer prevents relative vertical movement of the door and frame when such movement is not required to open the door.

The invention also encompasses a nursery gate incorporating a hinge described above.

1. A nursery gate hinge comprising first and second hinge parts hinged together by means of a hinge pin, a shroud assembly comprising a first shroud part substantially surrounding the first hinge part and a second shroud part substantially surrounding the second hinge part, the shroud parts being arranged to cover the first and second hinge parts and to prevent access thereto.

2. A nursery gate hinge according to claim 1 in which one shroud part is received within the other shroud part.

3. A nursery gate hinge according to claim 1 in which the first shroud part is a cup-like member comprising a substantially circular base and a substantially circular peripheral wall defining an open mouth and surrounding the first hinge part.

4. A nursery gate hinge according to claim 1 in which the second shroud part is a cup-like member comprising a substantially circular base and a substantially circular peripheral wall defining an open mouth and surrounding the second hinge part.

5. A nursery gate hinge according to claim 1 in which the first and second shroud parts are cup-like members, the cup-like members being arranged mouth to mouth.

6. A nursery gate hinge according to claim 1 in which the first shroud part is a cup-like member comprising a substantially circular base and a substantially circular peripheral wall defining an open mouth and surrounding the first hinge part, the second shroud part is a cup-like member comprising a substantially circular base and a substantially circular peripheral wall defining an open mouth and surrounding the second hinge part.

7. A nursery gate hinge according to claim 6 in which the first and second shroud parts are cup-like members, the cup-like members being arranged mouth to mouth.

8. A nursery gate hinge according to claim 6 in which the first shroud part is received within the second shroud part.

9. A nursery gate hinge according to claim 1 in which the first shroud part is received within the second shroud part.

10. A nursery gate hinge according to claim 1 in which the first and second shroud parts are arranged so as to enable relative rotation therebetween.

11. A nursery gate hinge according to claim 1 in which the first hinge part comprises a plate having an aperture formed therethrough for receiving the hinge pin.

12. A nursery gate hinge according to claim 1 in which the second hinge part comprises a plate having an aperture therein for receiving the hinge pin.

13. A nursery gate hinge according to claim 1 in which the first hinge part comprises two plates spaced apart from one another and joined by a connecting web, each plate having a respective aperture formed therein co-axially with the aperture in the other plate for receiving the hinge pin.

14. A nursery gate hinge according to claim 13 in which the second hinge part comprises a plate having an aperture therein for receiving the hinge pin, the plate of the second hinge part being arranged between the two plates of the first hinge part so that the apertures in the plates of the first hinge part and the aperture in the plate of the second hinge part lie coaxially.

15. A nursery gate hinge according to claim 1 in which a space is provided between the first and second hinge parts to allow movement therebetween.

16. A nursery gate hinge according to claim 14 in which a space is provided between the plate of the second hinge part and one of the parts of the first hinge parts.

17. A nursery gate hinge according to claim 1 wherein a space is provided between the first and second hinge parts to allow relative movement therebetween and wherein one shroud part is received within the other shroud part, the height of the portion of the shroud part received within the other shroud part being greater then the space between the first and second hinge parts.

18. A nursery gate hinge according to claim 15 in which there is provided a spacer block which can be fitted into the space to prevent such relative movement.

19. A nursery gate comprising a frame secured within an opening and a door hinged to the frame by means of a hinge, the hinge comprising first and second parts hinged together by means of a hinge pin, a shroud assembly comprising a first shroud part substantially surrounding the first hinge part and a second shroud part substantially surrounding the second hinge part, the shroud parts being arranged to cover the first and second hinge parts and to prevent access thereto.

20. A nursery gate according to claim 19 in which the first hinge part is attached to the frame of the nursery gate and the second hinge part is attached to the door of the nursery gate.
